(19) United States
(12) Patent Application Publication
(10) Pub. No.: US 2019/0281120 A1
(43) Pub. Date: Sep. 12, 2019

(54) METHOD FOR DESIGNING DATA AND OPERATION MANAGEMENT SYSTEM FOR THE MANUFACTURING, OPERATION AND MAINTENANCE OF IP DOOR CONTROLLERS

(71) Applicants: Martin H. Weik, III, Stanardsville, VA (US); Arthur Steven Weik, Fairfax, VA (US); Gary A. Altenberg, Buffalo, MN (US); Aaron Altscher, Columbia, MD (US); David Fields, Baltimore, MD (US)

(72) Inventors: Martin H. Weik, III, Stanardsville, VA (US); Arthur Steven Weik, Fairfax, VA (US); Gary A. Altenberg, Buffalo, MN (US); Aaron Altscher, Columbia, MD (US); David Fields, Baltimore, MD (US)

(21) Appl. No.: 15/917,554

(22) Filed: Mar. 9, 2018

(51) Int. Cl. H04L 29/08; E05F 15/603

(52) U.S. Cl. CPC H04L 67/125; H04L 67/34; E05Y 2900/40; E05Y 2201/434; E05Y 2900/11; E05F 15/603

(57) ABSTRACT

A system is designed for the management of the data and data files associated with the manufacturing, installation, operation and maintenance of a door motor control system typically found on industrial doors and gates. The system uses elements and programs useful to anyone familiar with common technologies such as APPs on Smartphones, thumb drives and touch screen display technologies. Since this familiarity already exists as a standard expertise among a broad range of people, the training component necessary to achieve competency in the field of motorized doors can be greatly reduced.

### CROSS REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention pertains to a system designed for the management of the data and data files associated with the manufacturing, installation, operation and maintenance of a door motor control system typically found on industrial doors and gates.

### BACKGROUND OF THE INVENTION

Door operators and door controllers are known in the prior art. See, for example, U.S. Pat. No. 6,737,823 to Reed, Bali; U.S. Pat. No. 6,388,412 to Reed et al.; and U.S. Pat. No. 7,509,991 to Weik. As doors and their operators become more complex and the supply chain for the parts becomes globalized the manufacturing supply chain can be spread to vendors across the world. Yet, each door and its operator is a piece of critical infrastructure to the property owner and building operator for security, environmental and operational reasons. This presents a supply chain problem for the assembly factory, the installer, the maintenance technicians and the end user operator of the space to which the door/gate is a barrier.

This is especially true for door/gate operators where the operator assembly parts are sourced by multiple vendors spread across the global marketplace. For instance, for high end industrial doors typically called high speed doors, door operators include an assembly of a Variable Frequency Drive (VFD) manufactured by one company, the control board designed by another and the position sensor by another, the motor and gearbox by another and the operational programming supplied in different versions by one or more software development companies that are either in house or contracted concerns.

To maintain a record of just what went into producing the final assembly and what version is in the unit is a daunting task for the manufacturer who is accustomed to relatively simple analog or micro controllers that operate in an environment not considered “smart” by today's standards. This has created a barrier for manufacturers to enter door operators into the internet of things (IoT) and slowed and inhibited innovation into more complex door controllers. For those who have attempted to make the entry, the step into IoT for doors has been fraught with high costs in fielding tech support and data management services within an industry not familiar with smart and IP technologies.

An additional barrier is the high cost of field setup of complex door control devices that must be borne by both the industry, and if it is a warranty issue, the installation company or the customer during its manufacturing, operation and maintenance life cycle. The field setup and factory setup parameters have become so varied and so complex that it is beyond the skills and capabilities of the door operator builders and door service technicians typically found in the door industry. At great cost door companies have bought technology companies, hired development expertise or created high cost tech support departments in an attempt to surmount the inherent difficulties. A pathway, then, is needed to simplify the construction, operation and maintenance of IP capable high end door operators to facilitate, simplify and manage the vast number of the program files, generated data files, and unique setup parameters of each operator and to keep track of the operational device and its many program files through its lifetime to include its construction, assembly, installation and operation.

A partial step in this direction is the advent of a programmable microcontroller for door controllers, but such devices do not have the capability to manage both the data and the immediate controller function of IP capable door operations simultaneously. The programs become too large and the boot time becomes unacceptable as a door is expected to operate when it is turned on immediately, not take a minute or a large part of a minute to boot up its application program. The micro-controller executes its program as a read and execute line by line system which becomes too slow once the program begins to expand beyond a reasonable size.

And, operators with VFD's (Variable Frequency Drives) are already complex devices. To add connectivity (IP capability), data management, event logging, motor speed /position control and real time fault diagnosis creates a complex issue where all principals and stakeholders must have their concerns satisfied on a single complex platform. The program becomes too large to execute line by line at a speed that is necessary to operate all motor control functions routinely, while building log files, connecting to a network, and building the associated data management logs on its operations.

To overcome the inherent hurdles and solve the aforementioned associated issues the following pathway is offered or considered as a preferred method of design, manufacture, installation implementation on a door of an IP networked and or a high-speed door controller. With the configuration proposed below, the individual units and their specific programs can be tracked through their life cycle for reasons, benefits, and cost reductions that will become clear to those familiar with and engaged in these arts.

### SUMMARY OF THE INVENTION

From the foregoing, it is seen that it is a problem in the art to provide a device meeting the above requirements. According to the present invention, a device is provided which meets the aforementioned requirements and needs in the prior art.

The present invention provides a relatively easy and transparent pathway to organize the various programs and data files unique to each door operator so as to be able to overcome the high costs and the technology barriers inherent in the construction, operation and maintenance of high end IP capable door operators.

In accordance with the present invention, each primary component listed herein will be individually familiar to anyone having skill in the respective arts. The present invention is able to combine these devices to provide collaboration among door motor/gearbox suppliers, motion control experts, computer experts including the SBC (Single Board Computer) variant, servers and IP server networks operators, file and data management experts, APP builders and touch screen human interface developers and programmers which results in an outcome that will overcome the inherent difficulties mentioned above.

In accordance with the present invention, parts are selected wherein each can be sourced along with its associated experts and their technical support team where the final assembly then becomes primarily an integration issue of separate components that each has their associated expert design and supply chain expertise.

The present invention is not merely an attempt to build a single platform that can control the motor current, gather signals from the associated sensor network, generate operational data and connect to a server from a single PCB (printed circuit board) platform. Rather, the present invention provides for a carefully chosen set of primary components and an improved preferred method of construction and operations management of an integrating control platform to construct a IP capable door operator motor control system.

The present invention arises primarily from readily available components except for a single integrating component (control board) that, once assembled with the integrating component and operational data management and operating programs, will make the construction, installation, setup, operation and maintenance of single and variable speed IP door controllers and operators within the capabilities and familiar to to anyone already familiar with common technologies such as APPs on Smartphoncs, thumb drives and touch screen display technologies. Since this familiarity already exists as a standard expertise among a broad range of people, the training component necessary to achieve competency in the field of motorized doors can be greatly reduced.

By tapping into technologies that are more commonly understood by a broad range of individuals, the pathway to becoming a competent servicing technician can be greatly simplified saving both time and money for both the industry and its customers.

The present inventive system will track the program files of each door motor control box, provide an automatic or easily available familiar pathway for upgrades to the operating programs and a system that tracks the programs installed in each door control box so that in the event of operator failure, replacement or software update, the correct program can be pulled from the archive and be easily reinstalled. This includes complex program files associated with timers, schedulers and run parameters and all the components of the door motor control system that have programmable media.

The preferred data connected components of this door control system invention include the following: Mitsubishi VFD (Variable Frequency Drive) or equivalent with its configuration files with or without a data link but with the necessary VFD control functions as I/O on the Control Board, wherein the Control Board is preferably a device known commercially as an SDS-0300 Controller offered commercially through Smartdoor Systems, Inc.; a control board based on an FPGA (field programmable gate array) to manage I/O and its program) with a micro controller with processor and associated program linked to the FPGA, along with associated connectors, power supplies, relays, etc., needed to perform the necessary I/O function described herein; a SBC (Single Board Computer) with a data link to the Control Board; the data link being any common data transfer technology not limited to blue tooth, USB, or serial formats, the SBC such as BlueChip Technologies' Beta 712H and its program with removable memory device typically a SD card with data link to the Internet, Smartphone or larger touch display type screen; with or without a SBC adaptor board; server with data connection to SBC, server with custom program, Internet; application programs PC or laptop computer application programs, and the limit position sensor, the motor and the gearbox.

The above mentioned parts and the roles they each play in supporting the operational outcome are detailed below. In addition to these primary components, various connectors, power supplies, transformer and fuses may be included as needed based on motor and accessory needs, housed in a control box enclosure or enclosures.

Other objects and advantages of the present invention will be more readily apparent from the following detailed description when read in conjunction with the accompanying. drawings.

### BRIEF DESCRIPTION OF THE DRAWINGS

FIG. 1 is a schematic view of the system and method according to the present invention.

FIG. 2 is a schematic diagram of an app screen with functions shown as elements that can be selected.

FIG. 3 is a schematic diagram of a screen showing additional control elements and functions as elements that can be selected.

FIG. 4 is a schematic diagram of a screen showing scheduling options as additional control cicmcnts that can be selected.

FIG. 5 shows a status display screen.

FIG. 6 shows two example screens showing in the top screen a control panel as elements that can be selected, and in the bottom screen there is shown lines of computer code for viewing by a user.

### DETAILED DESCRIPTION OF THE INVENTION

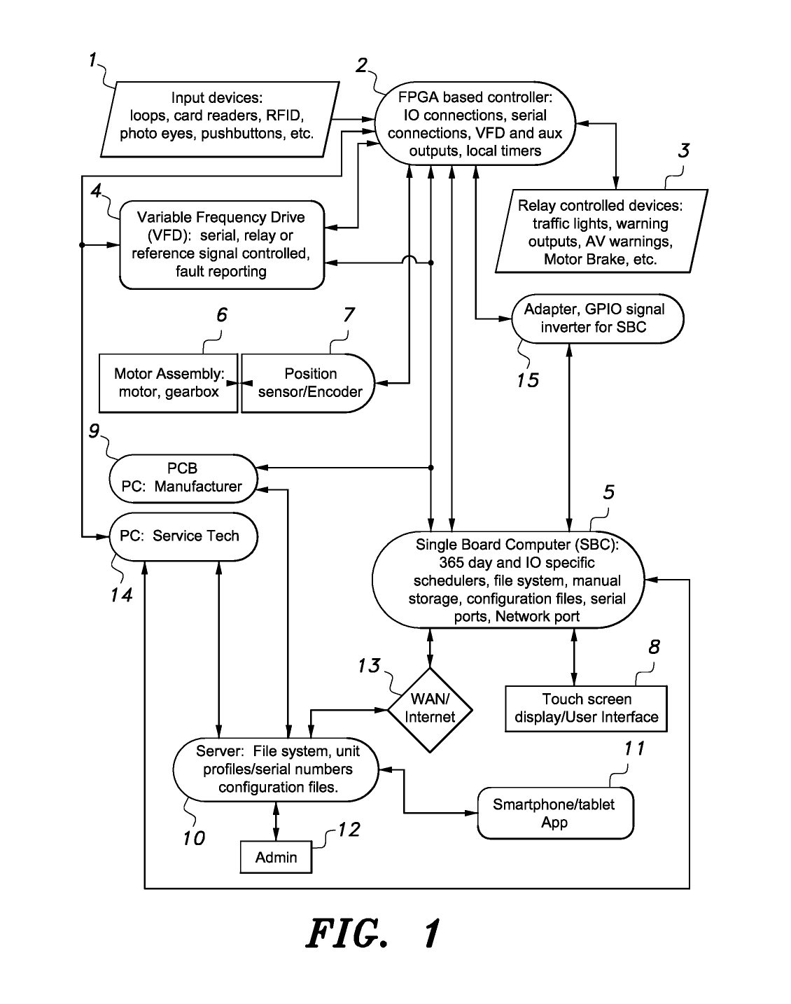

FIG. 1 is a schematic view of the system 100 according to the present invention. FIG. 1 shows the power, data or signal pathways between components that switch control signals on and off, and that carry data within the system components that process data signals. The connections between the components that pass data in both directions have arrows at each end.

Otherwise, the connection is represented with a single arrow at one end to signify a signal or data pathway in one direction. Lines that have no arrows represent line power in/motor power out. Each box also represents a distinct component although the assembly process might have a component attached mechanically to another or have embedded signal or data pathways that carry signals from a first device to a third device. The point is to show the components in a preferred embodiment to achieve the operational invention of the system. Not shown are electric current power supply pathways to each device as the necessity that these components are powered is obvious and adding additional lines adds nothing to the explanation and would reduce the clarity.

FIG.1 shows a plurality of input control devices 1. Typically, doors have many control devices used to open; stop, close and safety reverse the door.

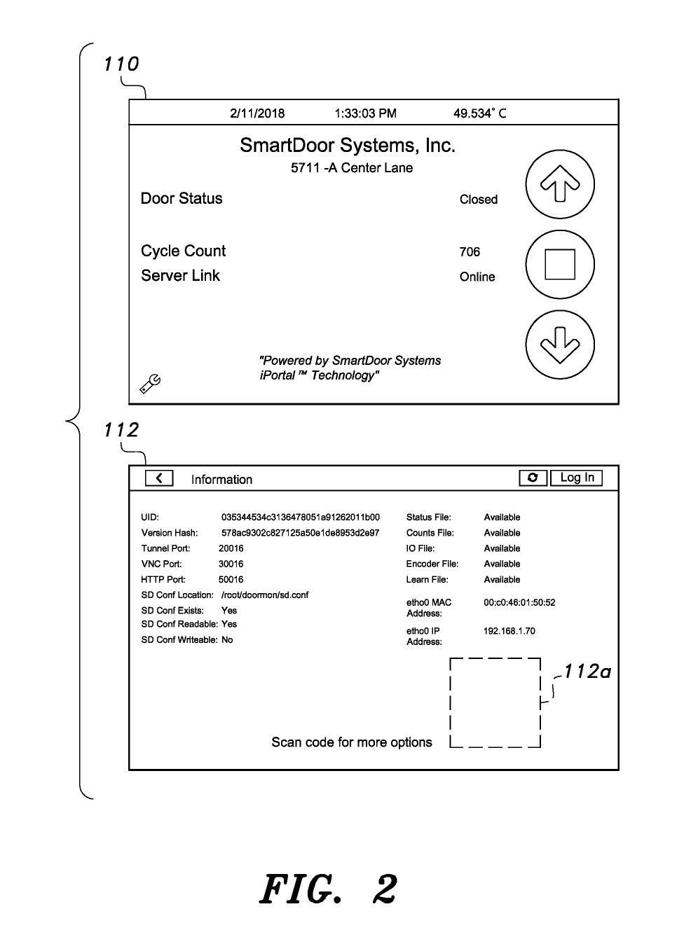

FIG. 2 is a schematic diagram of an app screen with functions shown as elements that can be selected.

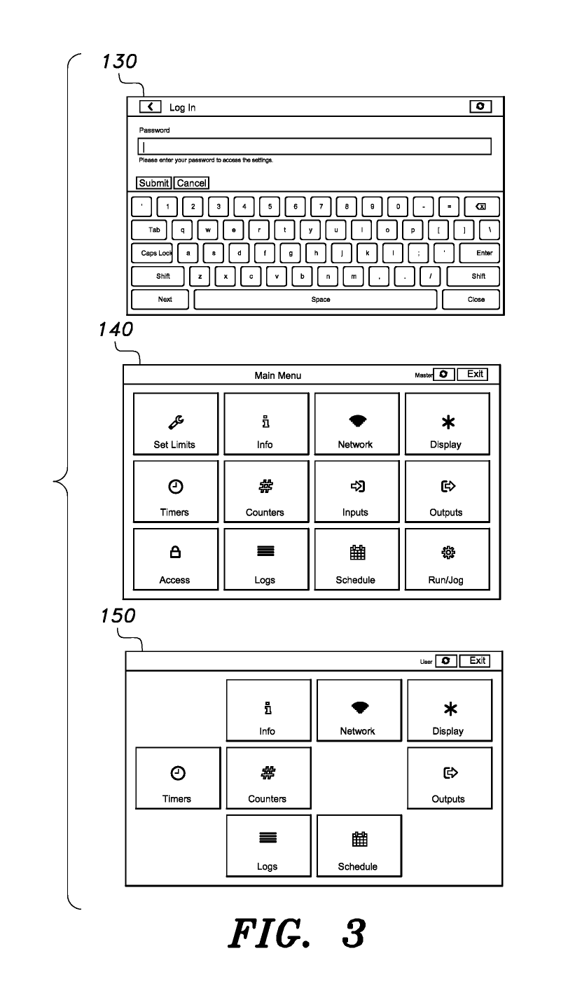

FIG. 3 is a schematic diagram of a screen showing additional control elements and functions as elements that can be selected.

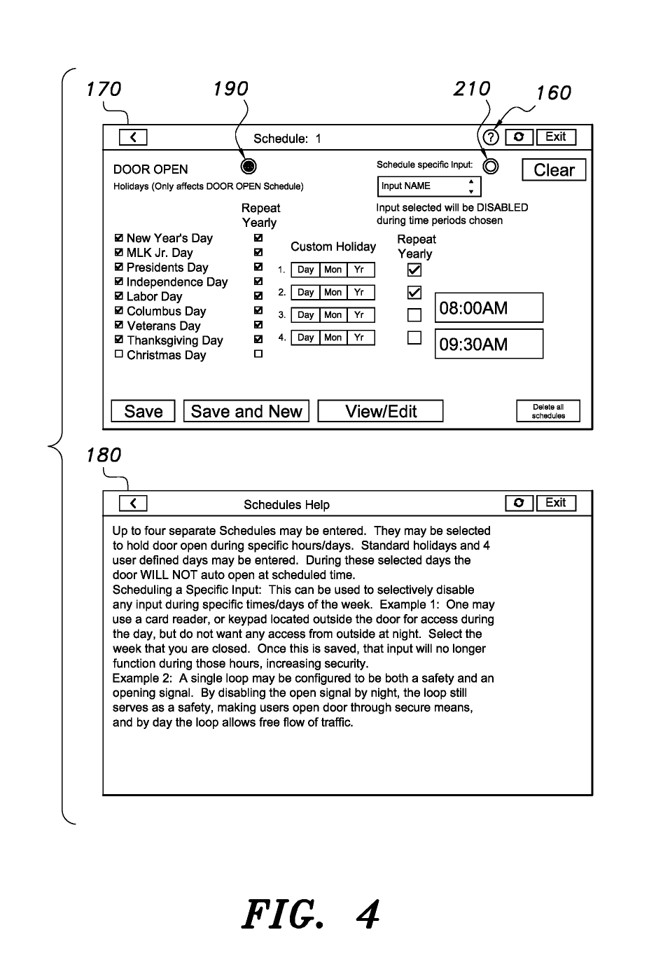

FIG. 4 is a schematic diagram of a screen showing scheduling options as additional control elements that can be selected.

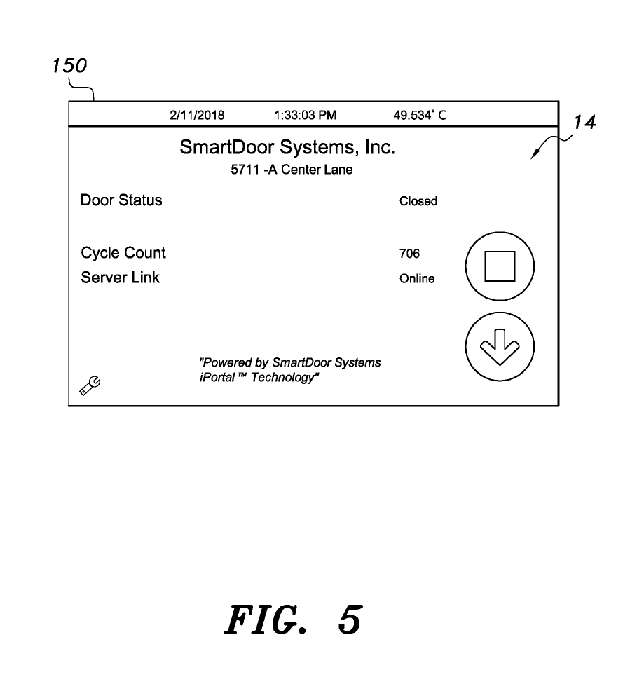

FIG. 5 shows a status display screen.

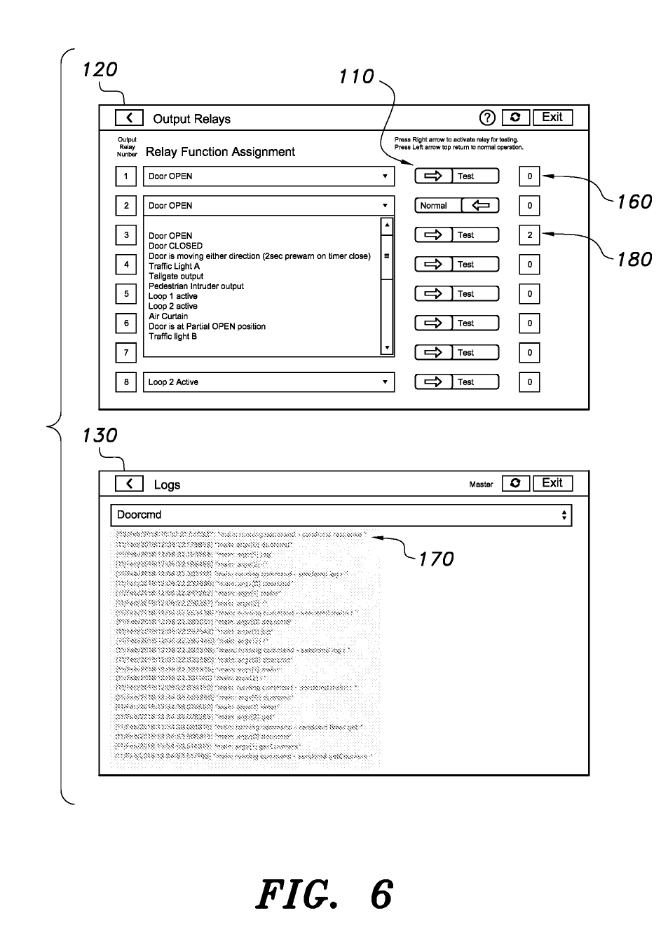

FIG. 6 shows two example screens showing in the top screen a control panel as elements that can be selected, and in the bottom screen there is shown lines of computer code for viewing by a user. Those skilled in the art will recognize that these devices include but are not limited to and are commonly called push buttons, electric eyes, loop detectors, radio receivers, safety edges, ceiling pulls, key switch, push button keypads, and many other named devices that open, close, stop, or safety reverse the door. In addition there are devices that indicate door position such as limit switches that indicate the top and bottom stop position, encoder position sensors, magnetic pulse generators, and motor current overload sensors, and/or manual chain engagement switches that indicate the manual chain hoist is engaged; all can generate signals that control door operations.

Typically, these devices are “dry contact” switches (except the encoder and pulse generator) that function in the circuit as either open (off) or closed (on). Dry contact means that the controller circuit supplies power (current) to the switch control device and the control device then allows or interrupts the current flow. Some devices are monitored which means that the control board (discussed in further detail in the FPGA section) can sense that they are connected as well as sense their ON or OFF state.

FIG. 1 schematically shows a plurality of multiple input control devices 1 and a controller 2, which is an FPGA based Control Board (State Machines). FIG. 1 also shows a plurality of relay controlled devices 3; a variable frequency drive 4, hereafter referred to as a VFD 4; a single board computer 5, hereafter referred to as an SBC 5; a motor assembly 6; a position sensor/encoder 7; a display 8; a PC manufacturer 9 wherein “PC manufacturer” is a term defined herein as a manufacturer that uses a PC for programming, including for remote programming; a server 10; a Smartphone/Tablet computer App 11; an Admin (Administrator) 12; a WAN/Internet 13; and a PC service tech (service technician) 14 who is a technician with a computer who is able to remotely communicate with and program the devices. The term PC service tech is intended to be used as above, and is not intended to refer to a computer repair person as such. The computer used can be any commonly called a laptop, desktop, pad, smartphone, smart device or PC (personal computer).

The Control Board of the controller 2 is preferably a printed circuit board designed around a Field Programmable Gate Array (FPGA) and a microcontroller with a processor. The FPGA is designed (using a hardware description language) to contain hardware logic circuits that create logical paths from inputs to outputs. After the FPGA is configured the internal logic is the same as having hardware logic gates on the board. The control board FPGA of the controller 2 monitors inputs (signals) from the multiple input control devices 1.

The logic gates of the FPGA of the controller 2 are configured such that any signal from any device can result in an immediate change in state in regards to the conditions of stopped, run opening, or run closing. Those having skill in the art will recognize this as a “state machine” design.

The FPGA stores event and status information and generates an interrupt to the microcontroller when new information is available. The microcontroller (of the controller 2) reads the event and status information from the FGPA and sends this information to the SBC.

The status and event information is used by the SBC to create and store activity logs. The FPGA logic responds to the operator type; single speed or variable; where position sensing determines if the door should run at a constant or fast, medium or slow speed, or stop. Typically, when opening, a faster speed is chosen and a medium speed when closing. When the door position is near to the full open or near full close position as determined a position sensor (encoder or limit switch), the FPGA logic will set a slow speed and stops the door when it reaches the final open or close set point position by switching on the brake activation circuit relay on the Control Board of the controller 2 and configuring the VFD control relays on the Control Board to the OFF configuration. The single speed type responds to a go or stop command in either direction.

To further perform a smooth stopping function, a delay between turning off the power to the motor 6 via VFD off relay configuration, or relays that control the motor starter relays and the setting of the brake (one of the plurality of devices 3), can be programmed into the FPGA logic. The FPGA logic can be configured to turn on or off multiple relays on the Control Board to act as dry contact on/off switches that furnish the necessary signaling to control the brake, and control other accessory devices (among the plurality of devices 3) such as warning lights or sounders, barrier gate arms, air curtains, heaters, security monitoring systems and the above mentioned relays that control the motor starter and as such are designated as relay switches and are commonly known to anyone having skill in the art.

The FPGA also contains configurable timers that can be used to wait for a programmable amount of time before closing the door automatically after it is opened, operating the relay that controls the brake or operating other outputs (relays). The state machine of the FPGA can consist of multiple state machines operating in concert in order to correctly control all the necessary I/O functions. All the activity of the FPGA is monitored by the microcontroller. This microcontroller is also used to configure the FPGA when booting. The microcontroller firmware contains a command interpreter that can be accessed via a USB port, by the SBC to update configuration information and to log the events of the FPGA.

The following relates to the plurality of devices 3, namely relay controlled devices. In conjunction with door operations it is advantageous to have one or more relays that can control door related devices such as warning lights, warning buzzers, heater fans, traffic lights, barrier gates, and the like that operate in conjunction with the door movement. These are among the plurality of devices 3. These relays are controlled by the FPGA logic of the controller 2.

The following relates to the VFD 4 (Variable Frequency Drive). A VFD 4 such as the Mitsubishi D700 series can provide the capability of soft start/ soft stop and ramp up to defined speed capability for motors designed to be powered by these devices. It is connected to the Control Board of the controller 2 by signals from the Control Board relays and also via a data connection such that configuration files can be sent to the VFD 4; and logs, errors and fault data can be collected from the VFD 4; and sent to the Control Board of the controller 2 and passed to the SBC 5 for storage or transmission to the server 10.

Alternatively, the VFD 4 can use a reference signal voltage or current, or data connection or PWM signal to control motor speed. It is a proven device that has its own engineering and production team that cnsures its capabilities.

The Single Board Computer (SBC) 5 is a preferred device to operate as a hub that manages the data flow between the local human interface (display screen 8) as well as any remote human interface via an APP on the smartphone 11; the data collection from the FPGA 2 forwarded by the microcontroller and generated by the logic in the FPGA 2; manage the display screen 11; handle the connectivity to the internet connection 13 to the server 10; and store and display install manuals and videos and provide trouble shooting instructions along with other functions typically found in computing and file management capability typically found in SBC's 5. The basic programs and capabilities of the SBC 5 include driving the display with both video and text, touch screen support, manage wired or wireless internet connection, connections, manage NFC and Bluetooth connections, file management, support multi format pages for set up and configuration, and organization and implementation of application files. All of these functions can be handled by open sourced Linux software that has its own supply chain of software developers and engineers that manage this capability independent to the door industry specifically and places no burden on the door industry for its use in their applications. The SBC's 5 can manage Wi-Fi and Bluetooth connections, onboard and removable memory (SD or other removable flash memory), support multiple serial ports, USB and TFT LCD touch screens with Linux software freely available and supported by a network of independent developers and engineers. When connected to a server and hence to the internet or intra net, the SBC 5 can operate either a small touch screen or a monitor or TV sized digital screen 8 that can display any message or video that can be transmitted through the internet and provide the infrastructure to display any information that can be transmitted via the internet such as advertising including parking fee and hours of operation information for the facility.

The SBC device 5 is preferably installed on site to function as a setup/settings access point for the Control Board of the controller 2 and the VFD 4 as well as a data storage and transmitter between the server and the door/gate operator Control Board and to facilitate the connection between the Control Board and a smart device such as a computer, tablet or Smartphone. . The SBC 5 devices are designed to interact with a remote web server as well as utilize the local web server (within the device) for online and offline functionality and data storage. The local Web server serves as the user interface enabling the device settings and other configurable components to function without Internet or remote server access. The SBC 5 requires a proprietary operating system image to run the requested operations. The proprietary operating system image is built and stored on the remote web server and managed through a recorded version library/directory. In this way, if a door controller fails, a replacement can be easily reconfigured from separately stored set up and operational data files.

The SBC 5 devices can initially be configured by writing the operating system image to an SD card, alternatively, configuration can be made through a network connection, serial or other means as typical to SBC's. On boot, the device determines if a server is available on the local network or Internet (WAN) connection. If a connection is available, the device queries the API (Application Program Interface) on the server, sending the version of the software running on the device. If a newer version of the software is available, the server returns an identifier for the new version. The device then follows the embedded instructions included in the new software version to update or hold a message for the door technician that states that a new version is available. Alternatively, software updates may also be installed with a USB storage device and using the user interface on the device touchscreen. If the software is up to date, nothing is downloaded at this step. If the image has not been configured, an all-inclusive update script is also available for unconfigured devices. This script will download the files and run the commands necessary for operation of the device.

New versions of the software can be uploaded to the server through the administrative interface. Pre-configured operating system images will also be available for download by installers. It is important to note that with this file structure, updates to capabilities, bug fixes, etc. could be applied without altering any local settings programmed by the installer such as limit position, output relay configurations, timers, input names/functions, or displayed information. After verifying the software version, the device then opens an SSH tunnel to the server. The SSH tunnel is encrypted and created through an SSH protocol connection. This permits remote access to the device despite potential network issues, such as firewalls. The device periodically polls the server to inform the server of its current network status and receive remote commands. Polling, or polled operation, in computer science, refers to actively sampling the status of an external device by a client program as a synchronous activity. Polling is most often used in terms of input/output (I/O), and is also referred to as polled I/O or software-driven I/O. This polling frequency is set by the software administrator and can be modified.

The configuration files are stored on the device to ensure uninterrupted operation in the event of a network outage. Additionally, with an internet connection, the configuration files can be updated through the system API.

The motor (and motor gearbox assembly) 6 is self-explanatory to those familiar with the art, and may be of any configuration appropriate for the door and use needed. The assembly may include a manual chain hoist for manual operation during power or electrical control failure with a manual hoist engagement sensor switch and a thermal switch in the motor to sense an overload condition. These sensors are wired to the controller and hence to the FPGA 2.

The position sensor/encoder 7 can determine the position of the door by any of various devices. Such position sensing devices include mechanical limit switches activated by a rotary cam or other device that indicates door position to the controller, Hall Effect devices or absolute position rotary encoders. Preference is given to an absolute encoder connected mechanically to a gear box that rotates the shaft relative to the door position. The electronics in the encoder contain a circuit that converts the shaft position to a digital numeric value. As the door position changes, the value changes such that the value is always the same for any given door position, and that value changes in a linear fashion with door movement. The measured value is stored for retrieval. The encoder circuit also has an RS-485 interface or other serial or data transmission method that is designed to be wired to a microcontroller. The microcontroller on the Control Board of the controller 2 is connected to the RS-485 interface and sends requests for position to the encoder at regular intervals. The encoder responds with the last saved position value of the encoder. Alternate methods are envisioned that may include mechanical or magnetic position switches, incremental encoders, or encoders with reference or “home” position.

In the preferred embodiment, the encoder position number is read by the encoder and sent as a specific integer to the controller. During a setup operation the specific number is determined and assigned to the open and closed position by the installer via the Touch Screen Display interface of the SBC. From this number, slow down points can be determined as specific counts subtracted from the stop position through a learning method contained in the Control Board firmware of the controller 2. This capability is not new but the ability to set or change the limit or slow down point remotely or reload the already determined position in a replacement controller is not a current capability and is unique to this design.

The touch screen display (TSD) 8 is a type of human to machine interface (HMI). Other types of displays can be used with interactive capabilities to create a HMI. The present invention is not limited to touch screen displays, and includes other types of interactive devices with display capabilities or screens in combination with hardware type buttons. Displays have become cheaper, larger, and more available, have better resolution and many manufacturers in other industries have added touch screen capabilities over the recent past. Many industrial controllers have integrated display screens of limited capability and size as they are driven typically by PLC's including U.S. Pat. No. 6,388,412 licensed by Overhead Door.

The screen including the one referenced driven by the limited capability of a PLC consists of displaying codes or abbreviated text that have to be looked up in a service manual. The Weik patent, U.S. Pat. No. 7,509,991 by contrast includes and envisions a plain English full text and graphic capable display with enough i/o to have each i/o on a separate terminal hookup that allows the controller to monitor and log each signal from a device separately, generate event logs, and report to a server specific operation or fault issues. The touch full graphic display HMI also allows for the installer to easily make setup entries as the screen can provide prompts and instructions to the setup installer that leads the technician to an operational condition without the need for manuals or intensive training. Step by step instructions for field setup can originate on the display that leads the installer to the needed setup conclusion curtailing or eliminating the need for a high cost technical support operation, as well as the printing, updating and distribution of a large paper manual. The screen can also display door operation status; encoder position; cycle count(s), percent or actual counts of remaining spring life; network connection status; location name and or address; time and date; or any other information useful to the development team, the installing and maintenance team, the building or facility operator or of concern to the public. The touch screen display can preferably include images of the open, close and stop buttons that when pressed can activate the door. This makes actual push buttons and their expense unnecessary and allows the buttons to be active or not based on a 24/7 365 time schedule that is part of the SBC programming. Additionally, based on the scheduler and or choices in the setup, each of the open, close and stop buttons can each be displayed or omitted from the display. A displayed button or physical button that simply didn't function based on a schedule, might invite the notion that it was simply malfunctioning and invite vandalism. Whereas a button not displayed or not physically present would make the function inaccessible.

There are problems associated with SBC and Touch Screen Display door control buttons that can be overcome using GPIO outputs on the SBC. A General Purpose Input/output (GPIO) is an interface available on most modern SBC to provide an ease of access to the devices internal properties. Generally, there are multiple GPIO pins on a single SBC for the use of multiple interaction so simultaneous application.

Most commands and status information is transferred from the Door Controller to the SBC using a USB connection. Commands for opening, closing and stopping the door have a slight delay because of the software levels required to send a command to the Door Controller via the USB port. Using the GPIO hardware option to send open, close and stop commands to the Door Controller is much faster, more responsive and more reliable than using software commands through the USB or data connection. It was also designed to create easy connections for signals from the Door Controller to the SBC. There are multiple General Purpose Input /Output (GPIO) lines available to general use on typical SBC. These pins are accessible via a header on the on the SBC. The signals are low when the SBC powers up. To use these signals without any other circuit, the inputs on the Door Controller would have to be set to normally closed (NC) where upon boot up the NC position could generate a signal to operate/activate the door to run the door. This means that upon any power loss, on power restoration the door might move on its own. Additionally, if a wire from an SBC GPIO to the Door Controller where to break or become disconnected the door would get a run command. If both the open and close input wires where to break or disconnect the door would get a both run open and run close signal. For these reasons, the Open and Close signals from the SBC need to be inverted.

To invert the GPIO output signals the adapter was designed to use two open collector digital isolators. The isolators can be optical, RF, capacitive or any other technology available in digital isolators. Typically, optical isolators are used for this type of application however for this version an RF digital isolator with capacitive coupling was used. The input of the isolators has an anode and a cathode just like an optical isolator. The anode is connected to a GPIO pin of the SBC via a resistor. The cathode is connected to ground. The output of the isolator is an open collector field effect transistor (FET). The FET will only turn on when there is enough forward voltage (About 2 to 30 volts) across the anode and cathode inputs. When the voltage across the anode and cathode is below 0.8 volts the output FET will turn off. After power-up the GPIO pins will be low so the isolators will be off. When a GPIO pin is driven high the isolator will turn on thereby turning on the output FET. The output FET is wired with the Source pin connected to ground and the Drain pin is connect to the terminal block that will be wired to an input on the Door Controller. When the FET turns on the output is effectively connected to ground and the input on the Door Controller will be active. If a wire breaks it will be the same signal as if the FET was turned off so the door will not run. Of course, this capability could be built into the SBC GPIO pins and this adaptor would then become unnecessary.

Timers: I/O Specific timers and schedulers, in the FPGA 2.

Close timers that automatically close the door after a vehicle passes through it are critical to a functioning door and are integrated into the FPGA 2 referenced above and do not take time to load as an operations program at startup, the importance of this capability is already mentioned. A close timer of some type is typically implemented in most door operator designs. Other unique timers such as daily /weekly/holiday schedules are typically installed on doors as separate devices. This invention proposes not only a 356 day open/close scheduler but schedulers tied to individual I/O that would reside on the SBC. Individual timers that exist on operations files on the SBC can activate and deactivate individual functions on the I/O level. These timers would be set up on the SBC using the screen interface, an app on a cell phone with internet connection or Bluetooth directly to the SBC, and/or a USB thumb drive where the files are created on a computer desktop computer and transferred to the SBC. Additionally, beyond the typical day/weekly/holiday scheduler we see the need for timer/schedulers that can be attached to individual inputs or outputs that provide for individual control devices to be activated and deactivated.

By way of example: The trash hauler comes to the trash door from 6-7 AM on Wednesday. An individual I/O timer could activate a magnetic induction loop sensor input or a height sensor input only during that time that would allow the trash hauler to open the door only during that time window from his phone and not allow him to open the door at other random times.

Or, a shipping /receiving door is across the street from a residential address. Local codes require that the door only be operable during certain hours and cycle behind each delivery. Solution: A loop detector on the exterior can be set to a specific daily schedule for deliveries to automatically open the door when a truck pulls up during deliveries hours or as an arming device that allows another device to open the door; the close timer can close the door after each vehicle enters the dock area; and specific authorized individuals can open the door during a defined time windows based on the authorization schedule via key/keypad/cell/card device, etc., that creates authorization for that person for a preset time window.

Many more examples of control can be envisioned by persons familiar with door operations once the infrastructure is in place that allows specific i/o to be dedicated to a both a device and a time window it can function in.

The issue at hand then is that as the setup becomes ever more complex involving timers, schedulers on multiple control inputs, schedulers on associated controller controlled relays, door cycle count information, door speed settings for open and close, a way must be designed to create an image of the final setup and log files for reinsertion into a replacement controller in the event of controller failure so the average door technician can easily make the necessary repairs and get the door into operation.

The operator control unit assembly iiiauufaeturer:

The controller manufacturer and or unit assembly house would have a link to a server where it can pull from the server data files those programs that apply to each door type and archive either the program files that were installed for each controller or a library reference number to a file set for that particular door. In this way, replacement program files can be easily found and uploaded in standard ways such as USB thumb drive, SD card, internet connection, etc. A model number, serial number or Mac address that is unique to each controller is tied together in the server database for future reference.

The SERVER 10:

The internet 13 and the server 10 along with its specific application program constitute the environment in which the networked door controller can be constructed.

Not just the controller, but the controller, VFD, and/or SBC can have its files and settings stored on the server and downloaded for replacements.

The server 10 can hold archived program files for the system that programs the FPGA 2, the SBC 5, and the VFD 4 that can be downloaded to each component at point of manufacture specific to door type, voltage, etc. as called for in the production specification and application. The server 10 would also support the data collection from each network connected device, manage upgrades and “remember” the setup and program files for each controller by serial number, MAC address or other designation that identifies a specific controller. Support web pages, install directions, manuals and instructions stored on the server would also be uploaded to each controller during the manufacturing process. The server 10 would additionally be the connection point to operate applications that reside on Smartphones that “connect” to individual network connected door controllers. Notc that term “server” does not imply a single machine, but may be a single machine or leased server space, virtual servers, or multiple redundant units.

The SMARTPHONE/TABLET 11:

The application (APP) on the cell phone or tablet computer allows the user to perform many functions beyond just opening and closing the door remotely. With the system envisioned here and in previous Weik patents set forth hereinabove at page 1 and which are and expressly included herein by reference thereto, the user will be able to connect to each door controller to diagnose malfunctions, reconfigure inputs and outputs, set schedule, perform remote opens via internet, or connect via Bluetooth or wire to review or download operations logs either stored on the unit or on the server. The smart device with its inherent internet connection becomes a pathway to connect the controller to the internet to down load logs, update programs, do configuration and setups and perform any function where an internet connection if only temporary is useful to monitor, change or enhance system performance. The installer or service technician would have ready access to easily alter, upgrade or monitor door functionality.

The Administrator 12:

The systems administrator 12 is charged with all aspects of “admin” typically found in computer networks. He or she sets criteria for who is authorized access or alter only that which is allowed by the Admin assigned level of authority.

The WAN/Internet 13:

This refers to the infrastructure to facilitate data flows between IP devices associated with the system. This is a well-known term of art, and encompasses all communication infrastructures.

The PC: Service Tech 14:

This includes the service Tech 14 and his or her computerSmart Device (Smartphone, Tablet or computer with its custom application program(s) set. There are four main functions that are conveniently performed on a service tech's Smart Device with a larger screen and larger keyboard typically but not limited to computer with its system application program and larger screen view space and/or to do functions that would otherwise be done on an internet enabled unit on a non-internet enabled unit. The computerSmart Device is then the connection to the internet and hence to the system server. Scheduler setup, custom i/o setup configuration, access card information, and reading downloading the event log history from the SBC 5. However, since the SBC 5 accepts a keyboard with a USB connection, a scheduler setup could be performed directly to the SBC 5. However, setting up the scheduler(s) and the controller i/o configuration could take some expansive amount of time and be uncomfortable to perform with a keyboard plugged into the door controller SBC 5 USB port. If it was done sitting in a comfortable chair with a full size screen, the tech's work would likely be facilitated. The scheduler(s) should therefore be preconfigured to a computer program and via a thumb drive or memory device such as a SD card then just uploaded on site if the unit is not internet enabled. Setting up card access data bases and I/O configurations of the controller are all other functions that can best be performed via computer and uploaded to the control system. The computer, once connected to the internet, can both pull programs from the server that can be uploaded to a non-internet enabled system and pull from the non-internet enabled system the setup information that is archived on the server for future reference as already explained as well as pulling diagnostic logs, settings, etc.

The applications:

Inherent in the text and mentioned in passing are the various applications in each of the programmable devices. The Control Board 2 with FPGA and microprocessor; the SBC 5; the PC 9; the Smartphone APP 11; and the server 10 all have custom programs to include Web pages for setup, viewing status, generating and managing operations data, setting up the Control Board 2, the Control Board's FPGA handling in real time all the I/0 and motor control and diagnosing faults, and the VFD 4 handling the high voltage needs of the motor and reporting faults to the Control Board 2. Behind these custom programs live all the other programs typically found in SBC's 5, servers 10, and the like. Since only the custom programs and applications have to be written; and all the other data management, file sharing and Web products infrastructure are open sourced and managed by experts not specifically tied to the door industry, the door industry can, using these already existing resources, enter the “Internet of Things” (IoT) era.

How the system operates:

The door distributor takes an order from a customer and determines the door size and type along with other determinates such as phase and voltage. The order is given to the factory that assigns an order number to the job or alternately creates a QR code or other unique identifier. Included in the order number or QR code are data composed of numbers or letters that designate the operator type and program type. The job number or QR code is forwarded to the operator assembly company and the operator is built that corresponds to the archived data set that corresponds to the order number and the job number becomes part of the data stored on the SBC. If the QR code system is used, the QR code can be displayed on the display screen and “read” by a cell phone QR code scanner or an image of it can be taken. After the unit is shipped and installed the setup parameters are saved and then the file associated with that operator is updated to include address and other relevant information to include setup parameters. The saved file is then uploaded to the server so that a copy exists to easily reload or replace a failed or replacement controller. The uploaded setup parameter file can be associated with the QR code attached to the unit on the server information file associated with a particular unit. The server only has to remember the program by type and the setup parameters associated with each unit. The server maintains an archive then for each door controller. Any changes to the setup parameters can be immediately uploaded to the “archive” on the server attached to that particular controller designed by a unique designate such as a QR code, serial number or Mac address. The event log is encrypted so that it cannot be altered or edited by the installing or maintenance companies that otherwise attempt to fraudulently alter the event log to indicate a warranted fault that is really a user or operator error such as a vehicle hitting the door. The event log is easily downloaded to a USB stick or other memory device and emailed to the tech support team at the factory. Alternately, if the unit is online, the tech support team at the factory can log into the log file via the SBC 5 and “see” its operational history and status or the Smart Device can facilitate the internet data link to the factory support team.

Designing the Tech Support 14 Conversation by Control Board 2 Design Choices:

When considering door Control Board design, besides the technical requirements that must be satisfied, the designer technician should also consider the nature of the linguistic network, the conversations of the parties, i.e. manufacturers, installers, service techs and user(s) that will generate conversations among themselves and each other throughout the unit life cycle. Of particular importance are the conversations that occur between installation and service technicians (this term is as defined above, i.e. technicians who have computer computers and are able to remotely program and set relevant devices as explained hereinabove) and tech support teams. The time spent in these conversations costs significant amounts of money. Any design then that can shorten or eliminate the nccd for tech support can be looked at favorably by the industry. This invention proposes a number particular design features that directly impact the length and necessity for tech support conversation.

When a door is installed for the first time and often after repairs, there are many reasons why it may fail to operate after it is turned on. In order to shorten or eliminate completely the time the service technician spends with tech support, certain design features can be built into the Control Board 2. Additionally, the Control Board 2′s software/programming, the local active human interface (what's displayed on the screen) and the layout of the entire door control assembly all come into play. In the present invention, the aforementioned features of the controller are critical timesavers and not currently found on door controllers. The usefulness and obviousness of these features will become apparent to those skilled in the art of door controller design after reading this text, but are not currently included in typical door controller design.

Design case #1.

Let's investigate a typical tech support dialogue. Is the power on? Or, Are there lights on the board? (The “lights” being LED's.) A “yes” answer gives the Tech support person some useful information. However, besides the typical 24 volt control circuit power the controller typically has other lower voltages to power different board mounted components and circuits. There could easily be three or four distinct voltages that are present on the panel derived from the primary power. With a LED for each voltage, all the same color unique from any other LED groups, the tech support person can ask “how many reds?” If the board has four when operating correctly and the field tech answers three, then the tech support person knows immediately that the board has power but a critical power circuit has burnt out and the board will need replacement. No further questioning is necessary and arrangements can be made to ship a replacement.

Design Case 2:

It is becoming more typical for controller designers to put an LED on each input to indicate that there is current flow, “lit” LED, or not flowing, un-lit LED, in the circuit to the control device. A “lit” LED indicates current flowing through a closed contact and a not “lit” LED indicates that the contact on the control device is open. However, for a door to operate some circuits must have current flow (be closed) and have other circuits where current must NOT flow i.e. be open.

Circuits must be open and closed in a particular configuration or the door won't operate at all. Therefore, in devices with control circuit current flow LED indicators, with some LEDs on and others off, the LEDs provide no easily discernible way to tell what they mean in regards to the state of the state machine controller referenced above. However, if the LED is instead tied to and controlled by the FPGA, in reference to its state and the control device function, the lit LED can indicate the state that the input is putting the Control Board into; not the on/off status of the control device. For want of a better term I am going to call this design for the control circuit indicator LEDs “Altered State LEDs” (ASLEDs) where the “Altered” state is a state different than the “ready to run” state of the FPGA State Machine that is necessary in order for the door to operate. An example will make this clear. For a door to operate, some control devices have to be on and others off as the normal condition. This sets up the “ready to run” condition of the state machine. Typically, door or gate control button set or activating device has and open, close and stop button. The open and close buttons are open dry contacts. And typically, the stop button is a closed dry contact that when pushed to stop the door or gate the dry contact goes to the open condition and the circuit is considered open. Keep in mind that the word “open” here has the same context for two distinct devices. An “open”, “close” and “stop” button refers to the door position which the motor is intended to drive the door towards. The “open” or “closed” dry contact is the presence of a air or electronic gap or not between the button contacts. An open door/gate creates a gap in the building wall or perimeter. An “open” circuit has a gap in it not allowing the current to flow. So the fundamental context is the same. Therefore, indicator LEDs tied to the open or closed condition of the circuits would create a Christmas tree effect difficult to interpret since multiple controller input circuits can be either open or closed to achieve a ready to run state. However, when the LED is tied to the FPGA, the LED can indicate the effect the circuit open or closed status is having on the FPGA state machine to put the Control Board into a state that is contrary to the expected “ready to run” or operating state; it is then in an “altered” state. In the case described here, a stop button that is often (but not in every case) is a normally closed dry contact would not be lit when properly wired and functional. With all the control devices circuits indicator LED's tied to the FPGA and programmed to be “lit” or “not lit” relative to the on or off status of the control device as it is programmed to function at “ready” state, any lit LED on the control device inputs would have special meaning i.e. make the state NOT ready to run within the context of the FPGA program as a circuit that is keeping the standard run condition from being present. So tech support 14 can ask, “Are any input circuit's LEDs lit?” Not, “how many and which ones?” Additionally, all the control device inputs can be grouped together along a common edge and a common color so the question becomes, “Are any LEDs lit along the bottom edge (or in a particular group)?” If the answer is “no” he or she moves on. If “yes”, then “OK which one?” “OK. Third group, third input from left. That's the stop button. Check to see it it's wired up and if it's to the NC (normally closed) contact.” And so on. By having each input going to a unique singular connection point, where the fault condition is easily diagnosable by an ASLED controlled by the FPGA, maybe we don't need tech support at all except in rare difficult cases.

Case #3.

LCD Touch Screen 8 with SBC 5 machine to human interface:

The LCD touch screen 8 combined with an SBC 5 offers added capability to impact the tech support conversation. The large LCD touch screen combined with the capability of the SBC makes the unit capable of showing installation videos, offering tips on controller setup(s), leading the tech on a step by step setup process where choices are offered and entered chosen from a defined group of allowed answers (drop down menus) and holding files that print to screen such as installation manuals. By having setup menus that lead the technician through the complete setup process and only accepting choices that make sense within the context of a definable endpoint already determined by the factory loaded program for the specific door/operator/voltage/horsepower/type, the installer and tech support 14 only have to identify and verify that the program version is correct for the door/operator type. In incorrect unit program is installed due to some mix-up such as having different door operators earmarked to the same job but were to be mounted on different doors, rather than moving all the already mounted and wired hardware, maybe only the programs or parts of the program need be swapped. If the units are already on-line the tech support person can wipe and reload the program from his terminal, wipe and load specific files, change specific setup parameters, or otherwise perform any function within the system capability from his terminal. Or, if not on line, email the correct program or mail a thumb drive with the correct program to the service technician are examples of a non exhaustive set of possibilities among standard data sharing technologies. The capabilities inherent in a SBC create an environment where standard PC data sharing technologies exist by default in this much smaller device which the industry defines as a SBC.

Network conncction 13 to internet and local Bluetooth technologies:

The addition of the SBC to the primary component bill of materials for the door controller puts in play using the latest offerings from telecommunications carriers such as Verizon (for example) and other communication carriers for m2m technologies. Rather than routing the internet connection through wired routers and servers, (difficult and costly in the typical steel reinforced concrete locations where these doors are located) the connection can be made using a device that plugs into a USB slot on the SBC 5. For just a few dollars a month, the unit can achieve on line status at installation to achieve all the capabilities mentioned above.

The SBC 5, via a separate USB device or built in to the SBC 5, can use existing Bluetooth technologies to connect to a computer, tablet or phone for programming, door access, wireless accessories such as keyboards and mice as well as blue tooth enabled door accessories, sensors and control devices.

A Further Application:

A further application of the invention is to make an App for use on Smartphones and other Smart Devices. Here, the App would put the firedoor test system in place. In one preferred version of this invention, a video would be make of the door closing test; in viewing the video the user would hit or press a button on the app when they see the door start down in the Video and then press again (or alternatively press a further button provided for this purpose on the App) when the door is closed.

A data field would be present to fill in Door height. The App would calculate closing speed by time and height calculation and generate a pass/fail report. The entire test and video would be archived on server and aggregated by customer/ building address/ etc.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed:

1. A motor control system for controlling the motor of a motorized door or gate that is operably connected to a door or gate through a speed reducer that has at least an open position and a closed position with the motor capable of driving the door or gate to both the open and closed position, comprising:
an encoder adapted for determining position;
a controller having programmable media to include an FPGA and a processor; an SBC with an memory device which includes at least one of a fixed memory and a removable memory device and an insertable SD card; and
a touch screen display.

2. A motor control system according to claim 1 wherein said FPGA has an FPGA program; and
wherein said control board includes a plurality of indicator LEDs that are controlled by said FPGA to indicate whether the circuit they correspond to is active with respect to said FPGA program.

3. A motor control system according to claim 1 wherein said plurality of control board indicator LEDs are grouped by color according to their function and wherein said color is indicative of an active state when illuminated.

4. The motor system according to claim 1 wherein the some specific data displayed to the screen is uploaded to and stored in the SBC includes any of installation manuals, installation videos and/or troubleshooting guides that aid in at least one of the operation, installation and maintenance of at least one of the door and any related components.

5. The motor control system according to claim 1, wherein said SBC is connected to a server and wherein said SBC and said server are in communication such that they can communicate data with each other.

6. The motor control system according to claim 1, wherein a unique identifier is assigned to each of said controllers.

7. The system according to claim 1 wherein said touchscreen display can print to screen a unit unique identifier from among at least one of the following: a serial number, a QR code, a bar code, a Mac address, and a job number.

8. The system according to claim 1, wherein said touch screen display is connected to said SBC, wherein said touch screen display can accept signals from said SBC and can transmit signals to said SBC and display at least one of: coached step by step set-up instructions for at least one of the door and said motor control system; installation videos; troubleshooting guides; VFD fault status; door control device status as one of active and inactive; an event log generated by system activity; an encoder position status; an encoder fault status; a door cycle count; daily, weekly, monthly, and spring cycle count status; calculated remainder spring life; network connection status; time and date; system access keypad; operation buttons including open, close and stop; job number; system designate QR code; serial number; scheduler setup and status; any picture, video or data file that can be transmitted over the internet compatible with the SBC/display system; enable and display menus to configure the said micro controller setting options including at least run speeds, input active schedule, output control relay activate/deactivate schedule; set top limit; set bottom limit; set slow down points; and display facility operations status such as parking spaces availability message; remaining spaces; remaining vehicles at closing; vehicles exiting after closing number and time; and tailgater after closing activity log.

9. The system according to claim 7, further comprising a smart device having a scanning capability; and wherein a scan of said unique identifier by said smart device can automatically open a link between said smart device and said system server using a smart device network connection to cause menus to appear on the smart device which allow a technician to choose any of: order any of listed parts, order custom software upgrades, phone link to technical support, pose questions and connect to technical support via at least one of text, e-mail and chat; and wherein this activity can automatically update a unit historical record file archived on the server.

10. The system according to claim 5 wherein the smart device is connected to the internet where said smart device can create a communication link between the SBC and the system server such that data can be transferred between the SBC and the server.

11. The system according to claim 5, wherein software upgrades to said controller can be retrieved from said system server and uploaded to said controller without affecting local settings wherein said local settings include any of: limit position settings, output relay configurations, timers, input names/functions, scheduler settings, location name, building name, door name and any other unit unique displayed information.

12. The system according to claim 1, wherein said SBC is not connected to a server and wherein one of a computer, smartphone, tablet, smartpad, and an SD card and other removable memory device is used in place of a server connection and can then pass data from said server to said SBC.

13. The system according to claim 1, wherein at least one of said control board and said SBC can be connected to a computer.

14. The system according to claim 1, wherein configuration pages for said microcontroller exist as WEB pages in said SBC that, once opened by a computer connected to said SBC and configured, are automatically uploaded to said microcontroller and are saved locally on said computer, and wherein when said computer is connected to said server, configuration data can be uploaded and saved to said server.

15. A system according to claim 1, wherein a boot loader program the system operation files along with the unique identifier are uploaded to a SD card which once inserted into the SBC uploads program files to any of the SBC, the FPGA and the microcontroller processor.

16. The system according to claim 15 wherein said unique identifier, the program files uploaded by the manufacturer, and the configuration files are kept as retrievable records from which a complete replacement program and configuration data set can be generated and retrieved.

17. The system according to claim 16, wherein program updates and archiving of configuration files is an automated process.

18. The system according to claim 1, wherein when said SBC is in on-line status with said server, any one of multiples of the data displayed on the Touch Screen Display and system generated data files can be viewed remotely via any of said server, the Internet, said smart device, tablet, and computer data link by admin authorized personnel.

19. The system according to claim 17, wherein at least some of the system generated data files including the SBC event and activity logs can be encrypted, and wherein said data files are only un-encrypted at an admin authorized point including a factory tech support team terminal and a local display using an admin authorized access code.

20. The system according to claim 1, further comprising a unit/server/internet/admin authorized tech support terminal data link; and wherein said controller includes set up parameters that can be viewed and reset/configured via said unit/server/internet/admin authorized tech support terminal data link.

21. A system according to claim 1, further comprising set up pages stored in said controller; and wherein any individual i/o can have a 24/7/365 day scheduler assigned to it via said set up pages to selectively activate and deactivate the i/o according to the scheduler.

22. A system according to claim 1 wherein individualized access to any of setup, configuration parameters, and generated data can be restricted to defined individuals by assignment of a unique password to each user.
